(19) United States
(12) Patent Application Publication
(10) Pub. No.: US 2025/0241491 A1
(43) Pub. Date: Jul. 31, 2025

(54) METHOD AND APPARATUS FOR STORING COOKING UTENSILS DURING USE

(71) Applicant: Bethany Brewster, Brownstown, IN (US)

(72) Inventor: Bethany Brewster, Brownstown, IN (US)

(21) Appl. No.: 18/426,442

(22) Filed: Jan. 30, 2024

(51) Int. Cl. A47J 43/28

(52) U.S. Cl. CPC A47J 43/287

(57) ABSTRACT

An apparatus for holding cooking utensils, including an enclosure portion defining an elongated endless sidewall, a bottom member operationally connected to the endless sidewall, and an oppositely disposed top opening. A handle connection portion is operationally connected to the enclosure portion and disposed adjacent the top opening. A stabilization portion is operationally connected to one of the group consisting of the handle connection portion and the enclosure portion. The stabilization portion is typically magnetic, and the handle connection portion is typically contoured or contourable to engage an appliance handle.

### TECHNICAL FIELD

This specification relates generally to the field of food preparation devices and, more specifically, to an accessory for holding utensils for attachment to a slow cooker to facilitate storage and reduce mess of said utensils while not being actively used with the slow cooker.

### BACKGROUND

Slow cookers are ubiquitous kitchen appliances found in almost every kitchen, provided by a variety of vendors, and vary in their designs. Each slow cooker model typically utilizes a handle on one or both sides of the slow cooker. Some handles are solid and rectangular in shape while others are a semicircular; some are solid while others have a gap in the middle. Regardless of design, these handles enable the user to easily grasp and move the cooker. Utensils are typically not included with slow cookers, and therefore users select their own spoon, ladle, fork, or other utensils for use with the slow cooker while preparing and serving food. There is no predetermined designated area to hold a utensil during food preparation and serving. This presents a problem and inconvenience to users while removing food from the crock pot, as users typically place their utensils on a table beside the slow cooker. Typically, you will see plates and bowls used as utensil rests. This takes up additional space on a serving table when several slow cookers are used simultaneously. This also leads to unsightly messes when the utensils inevitably drip food on the table and/or utensil rest, space and mess. Thus, there is a need for more efficient method and apparatus for temporarily holding utensils for use with the slow cooker. The present novel technology addresses this need.

### BRIEF DESCRIPTION OF THE DRAWINGS

FIG. 1 depicts a top perspective view of a first embodiment utensil caddy according to the present novel technology.

FIG. 2 depicts a top plan perspective view of the utensil caddy of FIG. 1.

FIG. 3 depicts a first side elevation view of the utensil caddy of FIG. 1.

FIG. 4 depicts a second side elevation view of the utensil caddy of FIG. 1.

FIG. 5 is a perspective view of the embodiment of FIG. 1 as engaged with a slow cooker.

FIG. 6 depicts a top perspective view of a second embodiment utensil caddy according to the present novel technology.

FIG. 7 depicts a top plan perspective view of the utensil caddy of FIG. 6.

FIG. 8 depicts a first side elevation view of the utensil caddy of FIG. 6.

FIG. 9 depicts a second side elevation view of the utensil caddy of FIG. 6.

Like reference numbers and designations in the various drawings indicate like elements.

### DETAILED DESCRIPTION

Before the present methods, implementations, and systems are disclosed and described, it is to be understood that this invention is not limited to specific synthetic methods, specific components, implementation, or to particular compositions, and as such may, of course, vary. It is also to be understood that the terminology used herein is for the purpose of describing particular implementations only and is not intended to be limiting.

As used in the specification and the claims, the singular forms “a,” “an” and “the” include plural referents unless the context clearly dictates otherwise. Ranges may be expressed in ways including from “about” one particular value, and/or to “about” another particular value. When such a range is expressed, another implementation may include from the one particular value and/or to the other particular value. Similarly, when values are expressed as approximations, for example by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Similarly, “typical” or “typically” means that the subsequently described event or circumstance often, though may not always, occur and that the description includes instances where said event or circumstance occurs and instances where it does not.

The details of one or more embodiments of the subject matter described in this specification are set forth in the accompanying drawings and the description below. Other features, aspects, and advantages of the subject matter will become apparent from the description, the drawings, and the claims.

In general, the present novel technology relates to a storage container accessory 10 for attachment to a slow cooker, such as a crock pot, or like culinary device for storage of kitchen utensils when being used with the same. The storage container 10 includes a housing portion 15, and attachment portion 20, and a stabilization portion 25 for engaging a slow cooker 30.

The housing portion 15 is typically an elongated hollow member having an endless sidewall 35 operationally connected to a bottom member 40 and defining a open top aperture portion 45. Enclosure portion 15 is typically made of a structural material, such as metal, composite material, plastic, polycarbonate, mesh material, or the like. Housing portion 15 may be opaque, translucent, or transparent. In the case of a mesh material housing portion 15, the mesh size or aperture size is sufficiently small such that drippings form enclosed utensils 50 are captured therein due to their viscosity and/or surface tension preventing leakage through the mesh; however, such dripping residue may be forced therethrough during cleaning using a kitchen sink water sprayer or a dishwasher. The housing portion 15 may be rigid, and typically contoured to conform to a slow cooker handle 31, or may be flexible so as to snugly connect to slow cooker handles 31 (or sidewalls) of various profiles.

The attachment portion 20 typically defines a hook, clamp, clip, or the like 55 for engaging a slow cooker handle 31 (or sidewall), for suspension therefrom. Attachment portion is likewise made from a structural material, typically the same structural material making up the housing portion 15.

The stabilizing portion 25 operates to prevent the device 10 from experiencing unwanted movement or ‘wiggling’ when in use. The stabilizing portion is typically one or more magnets operationally connected to the housing and/or connection portions 15, 20 for magnetic engagement with the (typically metallic) outer surface of the slow cooker 30. In some embodiments, connection and stabilization portions 15, 20 are unitary.

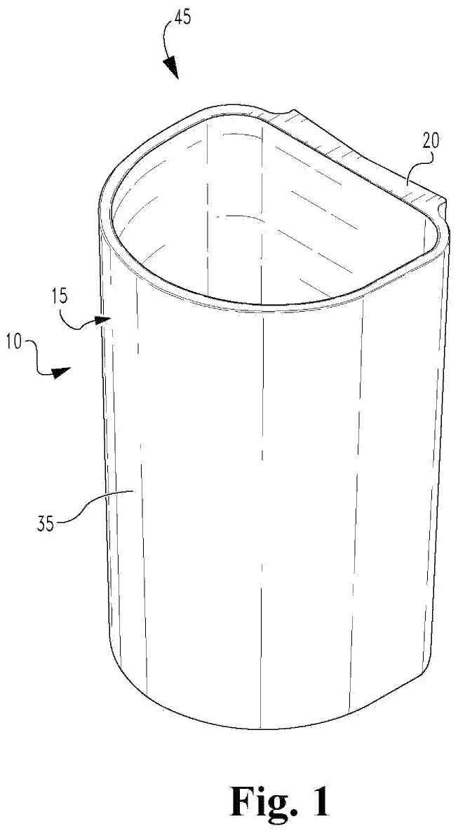

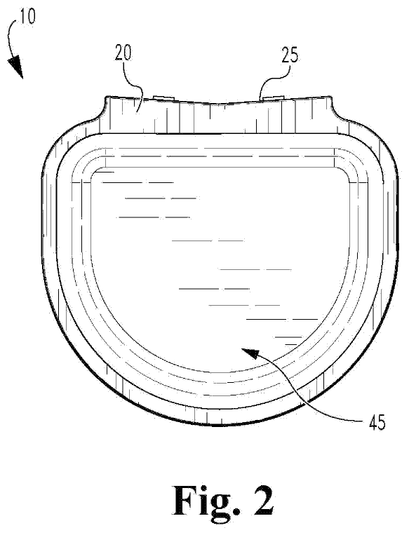

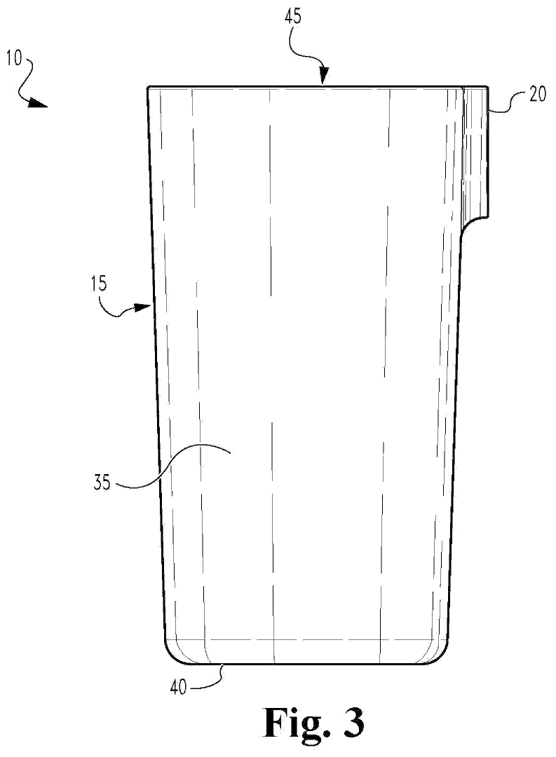

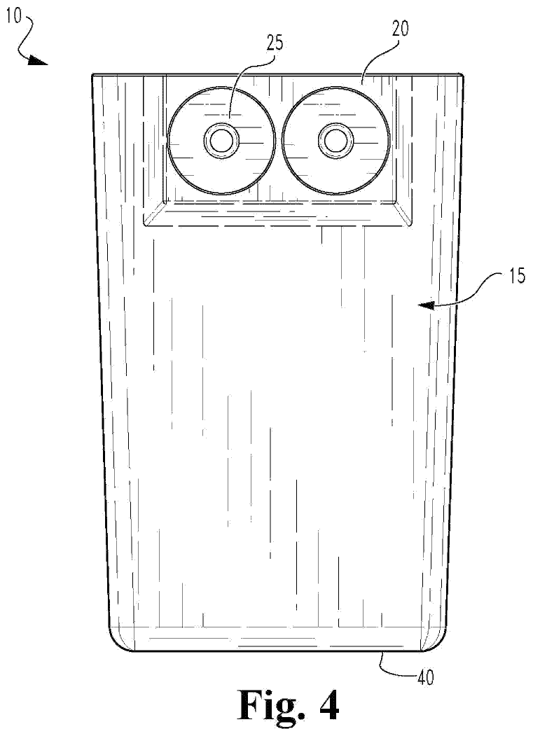

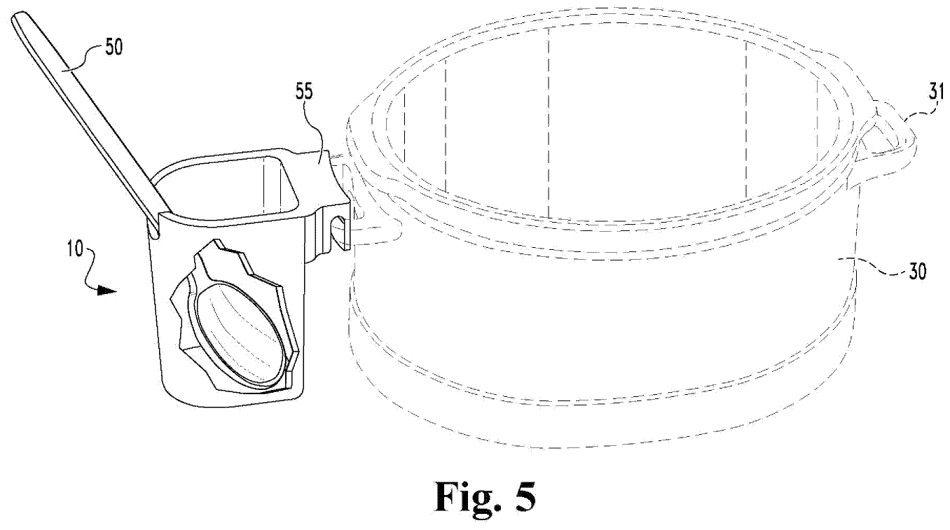

FIGS. 1-5 depict various perspectives and embodiments associated with the instant novel container system 10. Specifically, FIGS. 1-4 depict perspective, top, and side views of the present caddy system 10.

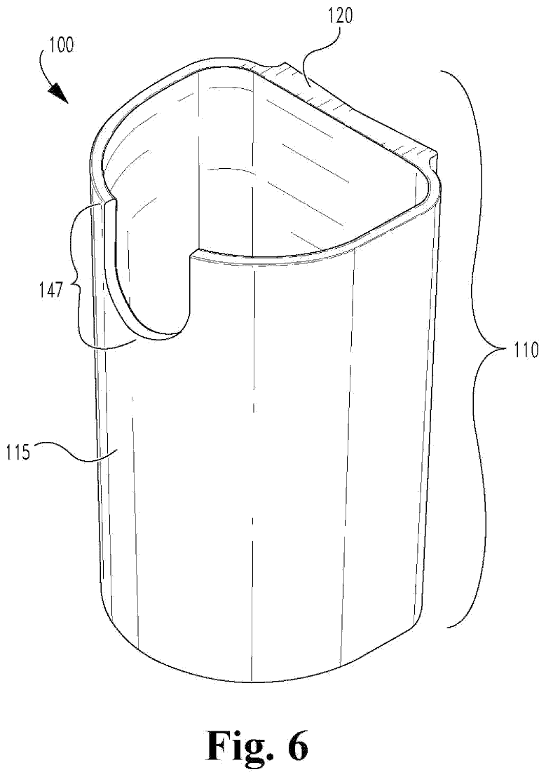

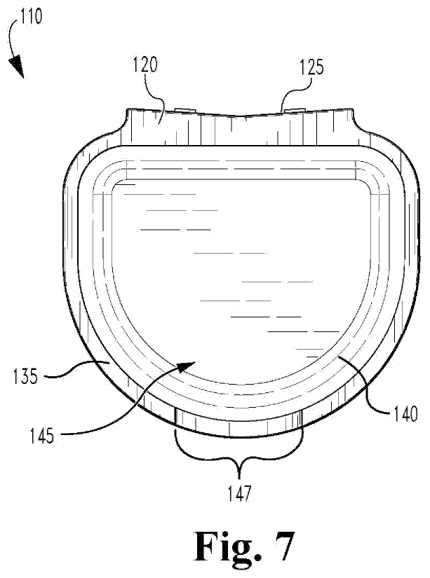

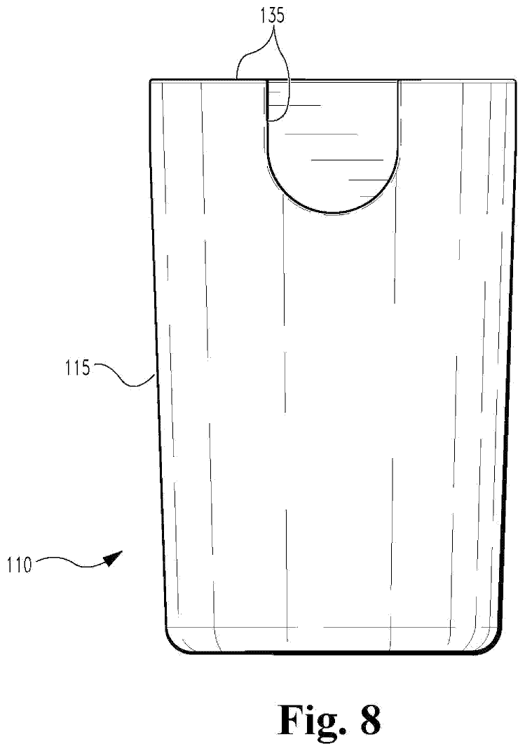

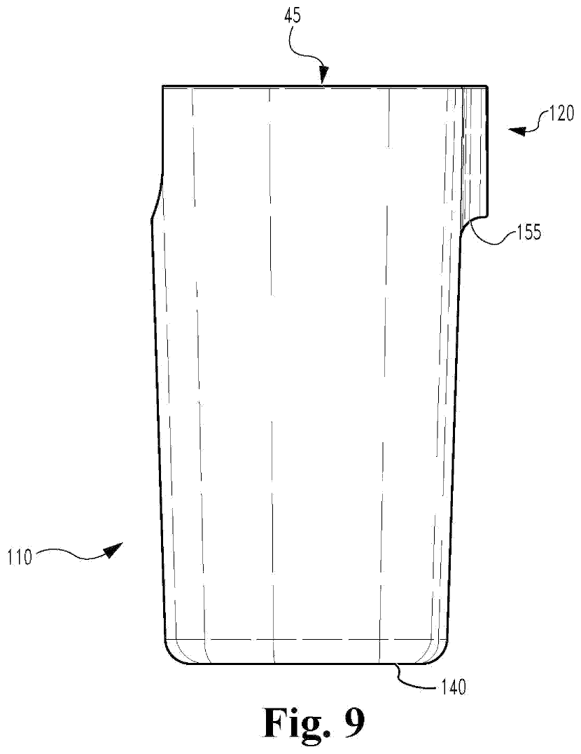

FIGS. 6-9 illustrate a second embodiment pf the present novel container system 100. The storage container 110 includes a housing portion 115, and attachment portion 120, and a stabilization portion 125 for engaging a slow cooker 30.

As with the previous embodiment 10, the housing portion 115 is typically an elongated hollow member having an endless sidewall 135 operationally connected to a bottom member 140 and defining an open top aperture portion 145. The sidewall 135 further includes a slot 147 extending to the aperture portion 145 to accommodate connection of the system 110 to various handle shapes and designs. Enclosure portion 115 is typically made of a structural material, such as metal, composite material, plastic, polycarbonate, mesh material, or the like. Housing portion 115 may be opaque, translucent, or transparent. In the case of a mesh material housing portion 115, the mesh size or aperture size is sufficiently small such that drippings from enclosed utensils 50 are captured therein due to their viscosity and/or surface tension preventing leakage through the mesh; however, such dripping residue may be forced therethrough during cleaning using a kitchen sink water sprayer or a dishwasher. The housing portion 115 may be rigid, and typically contoured to conform to a slow cooker handle 31, or may be flexible so as to snugly connect to slow cooker handles 31 (or sidewalls) of various profiles.

The attachment portion 120 typically defines a hook, clamp, clip, or the like 155 cooperating with the slot portion 147 for engaging a slow cooker handle 31 (or sidewall), for suspension therefrom. Attachment portion is likewise made from a structural material, typically the same structural material making up the housing portion 115.

The stabilizing portion 125 operates to prevent the device 110 from experiencing unwanted movement or ‘wiggling’ when in use. The stabilizing portion 125 is typically one or more magnets operationally connected to the housing and/or connection portions 115, 120 for magnetic engagement with the (typically metallic) outer surface of the slow cooker 30. In some embodiments, connection and stabilization portions 15, 20 are unitary.

In operation, the slow cooker 30 is positioned on a table or countertop and the utensil caddy 10, 110 is lockingly engaged to a slow cooker or like appliance handle 31 with the stabilizer portion 25, 125 magnetically coupled to the slow cooker 30. Utensils 50 are placed into the caddy 10, 110 for culinary use with the slow cooker 30. After each use of a respective utensil 50 (such as stirring the contents of the slow cooker 30, adding ingredients thereto, extracting and/or serving contents therefrom, and the like), said utensil 50 is replaced back into the caddy 10, 110. Drippings are captured and held within the caddy 10, 110. After the contents of the slow cooker 30 have been cooked, served, and/or the slow cooker 30 emptied, the caddy 10, 110 is disengaged therefrom and washed, such as in a kitchen sink or dishwasher.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

What is claimed is:

1. An assembly for holding utensils and capturing drippings, comprising:
a generally cylindrical housing portion including an endless sidewall, a bottom member operationally connected to the endless sidewall, and an oppositely disposed top aperture;
a handle connection portion operationally connected to the housing portion; and
a stabilization portion operationally connected to the handle connection portion.

2. The assembly of claim 1 wherein the housing portion is made of a mesh material.

3. The assembly of claim 1 wherein the stabilization portion is magnetic.

4. The assembly of claim 1 wherein the stabilization portion and handle connection portions are unitary.

5. The assembly of claim 1 wherein the handle connection portion is sufficiently flexible to contour to an appliance handle.

6. The assembly of claim 1 wherein the handle connection portion is engaged to a slow cooker handle.

7. The assembly of claim 1 wherein the handle connection portion is rigid and contoured to engage an appliance handle.

8. The assembly of claim 1 wherein the endless sidewall further comprises a spoon handle accepting slot formed therethrough.

9. An apparatus for holding cooking utensils, comprising:
an enclosure portion defining an elongated endless sidewall, a bottom member operationally connected to the endless sidewall, and an oppositely disposed top opening;
a handle connection portion operationally connected to the enclosure portion and disposed adjacent the top opening; and
a stabilization portion operationally connected to one of the group consisting of the handle connection portion and the enclosure portion;
wherein the stabilization portion is magnetic;
wherein the handle connection portion is contoured to engage an appliance handle.

10. The assembly of claim 9 wherein the handle connection portion is sufficiently flexible to contour to an appliance handle.

11. The assembly of claim 9 wherein the handle connection portion is engaged to a slow cooker handle.

12. The assembly of claim 9 wherein the enclosure portion is a mesh.

13. A method of using a slow cooker, comprising:
a) attaching a caddy to a slow cooker handle, wherein the caddy further comprises an enclosure portion defining an elongated endless sidewall, a bottom member operationally connected to the endless sidewall, and an oppositely disposed top opening; a handle connection portion operationally connected to the enclosure portion and disposed adjacent the top opening; and a magnetic stabilization portion operationally connected to one of the group consisting of the handle connection portion and the enclosure portion;
b) placing a cooking utensil into the caddy;
c) removing the cooking utensil from the caddy for use with the slow cooker;
d) replacing the cooking utensil into the caddy;
e) collecting drippings in the caddy;
f) removing the cooking utensil from the caddy for washing;
g) disconnecting the caddy from the slow cooker; and
h) washing the caddy.

14. The method of claim 13 wherein the handle connection portion is contoured to engage an appliance handle.

15. The method of claim 13 wherein the enclosure portion is a mesh.

16. The method of claim 13 wherein the handle connection portion is flexible.

17. The method of claim 13 wherein the endless sidewall further comprises a spoon handle accepting slot formed therethrough; and
i) after b), engaging the cooking utensil with the slot.
